(19) United States
(12) Patent Application Publication
(10) Pub. No.: US 2014/0305713 A1
(43) Pub. Date: Oct. 16, 2014

(54) OCCUPANT CLASSIFICATION APPARATUS USING LOAD SENSOR

(71) Applicant: DENSO CORPORATION, Kariya-city (JP)

(72) Inventor: Toshio Hosokawa, Anjo-city (JP)

(73) Assignee: DENSO CORPORATION, Kariya-city (JP)

(21) Appl. No.: 14/250,556

(22) Filed: Apr. 11, 2014

(30) Foreign Application Priority Data
Apr. 15, 2013 (JP) 2013-084702

(51) Int. Cl. B60R 21/015

(52) U.S. Cl. CPC B60R 21/015; B60R 2021/01516; B60R 2021/01575
USPC 177/136

(57) ABSTRACT

An occupant classification apparatus includes a load sensor, a longitudinal acceleration sensor, a lateral acceleration sensor, and a determinator. The load sensor detects a load of an occupant on a seat of a vehicle. The longitudinal acceleration sensor detects a longitudinal acceleration in a longitudinal direction of the vehicle. The lateral acceleration sensor detects a lateral acceleration in a lateral direction of the vehicle. The determinator performs a class determination process to determine presence or absence of the occupant and a size of the occupant by classifying the load into one of classes based on predetermined load thresholds. The determinator stops the class determination process when a vehicle acceleration is not less than a predetermined acceleration threshold. The vehicle acceleration is the square root of the sum of the square of the longitudinal acceleration and the square of the lateral acceleration.

### CROSS REFERENCE TO RELATED APPLICATION

This application is based on Japanese Patent Application No. 2013-84702 filed on Apr. 15, 2013, the contents of which are incorporated herein by reference.

### FIELD

The present disclosure relates to an occupant classification apparatus used to control a collision safety device, such as an airbag, by using a load sensor in a seat of a vehicle.

### BACKGROUND

When controlling a deployment of an airbag, it is preferable that the size of an occupant be detected in advance and a deployment mode of the airbag be controlled based on the detected size of the occupant. For this reason, in a conventional technique, a load sensor is built into a seat of a vehicle, and whether the seat is unoccupied, occupied by an adult, or occupied by a child is determined by comparing an output voltage of the load sensor with predetermined load thresholds.

However, an output of the load sensor can vary with a change in posture of the occupant and a change in acceleration exerted on the occupant while the vehicle is running. Therefore, if the load thresholds are fixed values, a determination error may occur temporarily.

JP-B-3570629 corresponding to US 2003/0154805A1 discloses a technique for solving such a disadvantage. In the technique, a load sensor detects a load on a seat of a vehicle, and a determinator classifies the load into one of classes based predetermined load thresholds to determine presence or absence of an occupant and the size of the occupant. When the detected load remains in the classified class for a predetermined time threshold, it is determined that a class transition between the classes occurs. Further, a time threshold used to determine one class transition is different from a time threshold used to determine another class transition.

Recently, to improve occupant protection performance, there has been a tendency to control an airbag in multiple modes according to the size of an occupant. Accordingly, the occupant needs to be classified into multiple classes.

In addition, to reduce cost of an occupant classification apparatus, there has been a desire to reduce the number of load sensors. Conventionally, occupant classification has been performed using four load sensors which are built into a seat of the vehicle to detect a load exerted on the entire seat. However, in recent years, it has been proposed to perform occupant classification using two sensors.

### SUMMARY

A disadvantage of reducing the number of load sensors in a seat to less than four is that when a load is concentrated on a portion of the seat where no load sensor is provided, the detected load becomes smaller, and when the load is concentrated on a portion of the seat where the load sensor is provided, the detected load becomes larger. Therefore, when the number of load sensors is reduced, the detected load varies largely depending on where the load is exerted on the seat. Further, as the number of classes into which the load is classified becomes larger, a load range for each class becomes narrower. Therefore, an error in a class transition between the classes may be likely to occur due to a change in posture of the occupant and a change in acceleration exerted on the occupant while the vehicle is running. This transition error may be reduced by increasing a time threshold which is used to determine whether the class transition occurs. However, this approach may take longer time to complete the occupant classification.

In view of the above, it is an object of the present disclosure to provide an occupant classification apparatus for accurately classifying an occupant of a vehicle with a reduced number of load sensors.

According to an aspect of the present disclosure, an occupant classification apparatus includes a load sensor, a longitudinal acceleration sensor, a lateral acceleration sensor, and a determinator. The load sensor detects a load of an occupant on a seat of a vehicle. The longitudinal acceleration sensor detects a longitudinal acceleration in a longitudinal direction of the vehicle. The lateral acceleration sensor detects a lateral acceleration in a lateral direction of the vehicle. The determinator performs a class determination process to determine presence or absence of the occupant and a size of the occupant by classifying the load into one of classes based on predetermined load thresholds. The determinator stops the class determination process when a vehicle acceleration is not less than a predetermined acceleration threshold. The vehicle acceleration is the square root of the sum of the square of the longitudinal acceleration and the square of the lateral acceleration.

Thus, even when the load of the occupant is concentrated on the load sensor due to acceleration while the vehicle is running, an error in the class determination process can be prevented from occurring. Therefore, an occupant protection apparatus, such as an airbag, is accurately controlled and activated according to the size of the occupant.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram for explaining accelerations detected by acceleration sensors of an occupant classification apparatus according to an embodiment of the present disclosure;

FIG. 2 is a graph of an acceleration threshold according to the embodiment;

FIG. 3 is a block diagram of the occupant classification apparatus according to the embodiment;

FIG. 4 is a diagram for explaining load classes and corresponding vehicle control modes according to the embodiment;

FIG. 5 is a flowchart of a class determination process performed when an occupant gets in of a vehicle equipped with the occupant classification apparatus according to the embodiment;

FIG. 6 is a flowchart of the class determination process performed when a class transition occurs from “infant in (CRS)” to “child”;

FIG. 7 is a flowchart of the class determination process performed when a class transition occurs from “child” to “adult (small)” or “infant in (CRS)”;

FIG. 8 is a flowchart of the class determination process performed when a class transition occurs from “adult (small)” to “adult (large)” or “child”;

FIG. 9 is a flowchart of the class determination process performed when a class transition occurs from “adult (large)” to “adult (small)”; and

FIG. 10 is a flowchart of the class determination process performed when the occupant gets off the vehicle.

### DETAILED DESCRIPTION

An embodiment of the present disclosure is described below with reference to the drawings.

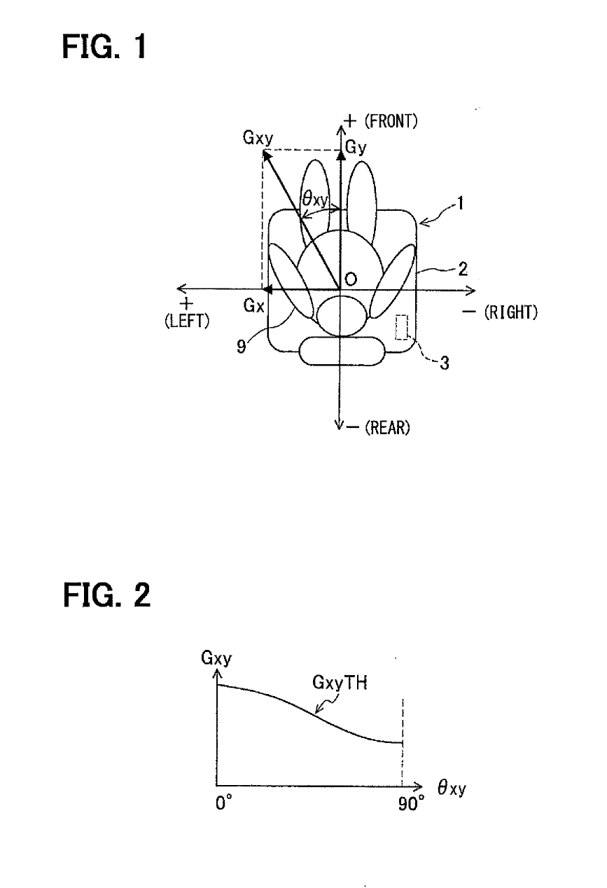

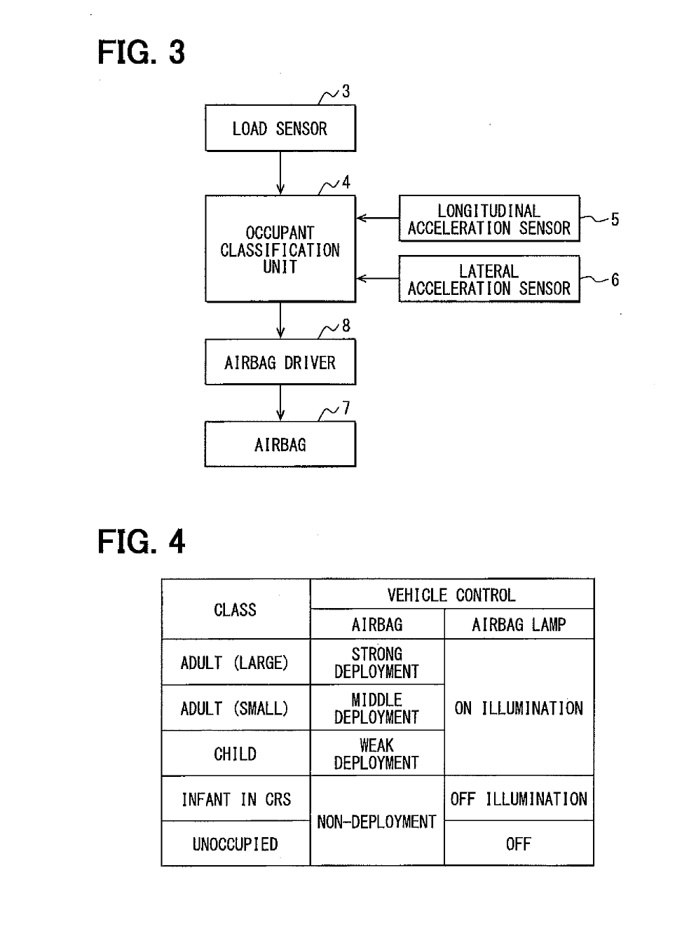

As shown in FIG. 1 and FIG. 3, an occupant classification apparatus according to the embodiment includes a load sensor 3, an occupant classification unit 4, a longitudinal acceleration sensor 5, and a lateral acceleration sensor 6. The load sensor 3 is installed on a leg of a seat 1. The leg of the seat 1 is located between a back side of a sitting portion 2 of the seat 1 and a floor of a vehicle body. The load sensor 3 detects part of a weight of an occupant sitting on the sitting portion 2 and outputs a load signal indicative of the detected weight. The longitudinal acceleration sensor 5 detects longitudinal acceleration of the vehicle and outputs a longitudinal acceleration signal indicative of the detected longitudinal acceleration. The lateral acceleration sensor 6 detects lateral acceleration of the vehicle and outputs a lateral acceleration signal indicative of the detected lateral acceleration. The occupant classification unit 4 includes an analog-to-digital (A/D) converter for processing the load signal, the longitudinal acceleration signal, and the lateral acceleration signal.

The load sensor 3 includes a pair of electrodes and a rubber layer having electrically conductive particles. An electrical resistance of the rubber layer decreases according to a compression force applied to the rubber layer. The rubber layer is sandwiched between the pair of electrodes so that one electrode can be in close contact with one side of the rubber layer and the other electrode can be in close in contact with the other side of the rubber layer. When an occupant 9 sits in the seat 1, an electrical resistance between the electrodes decreases according to a weight of the occupant 9. At this time, a predetermined direct current (DC) voltage is applied between the electrodes through a load resistance or a constant current flows between the electrodes through the load resistance, so that a voltage drop occurs. The voltage drop is converted to a digital signal by the AID converter, and part of the weight of the occupant 9 sitting on the sitting portion is detected based on the digital signal corresponding to the load signal. Alternatively, the load sensor 3 can be shaped in the form of a sheet and embedded in a front side of the sitting portion 2.

A type of the load sensor 3 is not limited to that described above. For example, the load sensor 3 can be a strain-gauge type, a semiconductor type, a capacitive type, or a magnetostrictive type. When any type of sensor is employed as the load sensor 3, an output of the load sensor 3 is an analog value. Therefore, the ND converter is necessary. In an example shown in FIG. 1, only one load sensor 3 is installed in the seat 1. Alternatively, multiple load sensors 3 can be installed in the seat 1 as necessary.

When multiple load sensors 3 are installed in the seat 1, the occupant classification unit 4 calculates a load W by summing load signals from the load sensors 3. Specifically, the occupant classification unit 4 calculates the load W by summing digital signals to which analog signals outputted from the load sensors 3 are converted by the ND converter. The load W can be calculated from an instantaneous value presently detected by the load sensor 3. Alternatively, the load W can be calculated from an average value over a predetermined last short period to remove high-frequency noise components.

A class L of the load W is determined based on load thresholds. According to the embodiment, as shown in FIG. 4, the load W is classified based on four load thresholds Wth1, Wth2, Wth3, and Wth4 into one of the following five classes: “unoccupied”, “infant in child seat (CRS)”, “child”, “adult (small)”, and “adult (large)”. The class “unoccupied” indicates that the seat 1 is unoccupied or vacant. The class “infant in CRS” indicates that an infant sits in a child seat installed on the seat 1. The class “child” indicates that a child sits in the seat 1. The class “adult (small)” indicates that a small adult sits in the seat 1. The class “adult (large)” indicates that a large adult sits in the seat 1. Of the four load thresholds, the first load threshold Wth1 is largest, the second load threshold Wth2 is the second largest, the third load threshold Wth3 is the third largest, and the fourth load threshold Wth4 is the smallest. That is, the load thresholds Wth1, Wth2, Wth3, and Wth4 have the following relationship: Wth1>Wth2>Wth3>Wth4. Then, the class of the load W is sent to an airbag driver 8. The airbag driver 8 controls an airbag 7 based on the class so that the airbag 7 can be operated in one of the following deployment modes according to the class: “non-deployment mode”, “weak deployment mode”, “middle deployment mode”, and “strong deployment mode”. In addition, the airbag driver 8 controls an airbag indicator light based on the operation mode of the airbag 7 so that the airbag indicator light can be operated in one of the following illumination modes according to the deployment mode of the airbag 7: “ON illumination mode”, “OFF illumination mode”, and “OFF mode”. The number of classes, into one of which the load W is classified based on the load thresholds Wth1, Wth2, Wth3, and Wth4, can be increased or reduced according to a type or size of the vehicle. The occupant classification unit 4 and the airbag driver 8 can be combined into a single unit.

Types of the longitudinal acceleration sensor 5 and the lateral acceleration sensor 6 are not limited to specific types. For example, the longitudinal acceleration sensor 5 and the lateral acceleration sensor 6 can be a mechanical type, an optical type, or a semiconductor type including a capacitive type, a piezoresistive type, and a gas temperature distribution type. In general, a semiconductor type acceleration sensor is commonly used in a vehicle.

The longitudinal acceleration sensor 5 and the lateral acceleration sensor 6 can be separate sensors or integrated into one sensor. The longitudinal acceleration sensor 5 and the lateral acceleration sensor 6 are placed in a predetermined location (e.g., floor) on the vehicle. The longitudinal acceleration sensor 5 and the lateral acceleration sensor 6 can be combined with the occupant classification unit 4 and/or the airbag driver 8 into a single unit.

When the vehicle is equipped with a vehicle behavior stabilization system, which performs stabilization control to prevent the vehicle from skidding when the vehicle makes a sharp turn at a corner or the like, the longitudinal acceleration sensor 5 and the lateral acceleration sensor 6 can be made unnecessary because acceleration information of the vehicle can be obtained from the vehicle behavior stabilization system and used instead of the acceleration signals. In this case, the occupant classification unit 4 receives the acceleration information from the vehicle behavior stabilization system through a controller area network (CAN), which is a local area network for devices mounted on a vehicle. Alternatively, when the longitudinal acceleration sensor 5 and the lateral acceleration sensor 6 are mounted on the vehicle, the vehicle behavior stabilization system can receive the acceleration signals from the longitudinal acceleration sensor 5 and the lateral acceleration sensor 6 through a CAN and perform the stabilization control based on the acceleration signals. In this case, the class can be accurately determined by synchronizing the acceleration detection with the load detection.

As shown in FIG. 1, the longitudinal acceleration sensor 5 detects a longitudinal acceleration Gy of the vehicle and outputs a longitudinal acceleration signal indicative of the detected longitudinal acceleration Gy to the occupant classification unit 4. According to the embodiment, when the direction of the longitudinal acceleration Gy is to the front, the longitudinal acceleration Gy is positive (+), and when the direction of the longitudinal acceleration Gy is to the rear, the longitudinal acceleration Gy is negative (−). Likewise, the lateral acceleration sensor 6 detects a lateral acceleration Gx of the vehicle and outputs a lateral acceleration signal indicative of the detected lateral acceleration Gx to the occupant classification unit 4. According to the embodiment, when the direction of the lateral acceleration Gx is to the left, the lateral acceleration Gx is positive (+), and when the direction of the lateral acceleration Gx is to the right, the lateral acceleration Gx is negative (−). The occupant classification unit 4 calculates a vehicle acceleration Gxy as follows:

Gxy=√(Gx²+Gy²).

That is, the vehicle acceleration Gxy is the square root of the sum of the square of the lateral acceleration Gx and the square of the longitudinal acceleration Gy. The vehicle acceleration Gxy forms an acceleration angle Oxy with the longitudinal acceleration Gy. The acceleration angle θxy is calculated as follows:

θxy=tan⁻¹(|Gx|/|/|Gy|).

That is, the acceleration angle θxy is the arctangent of a ratio of an absolute value of the lateral acceleration Gx to an absolute value of the longitudinal acceleration Gy. It is noted that when the longitudinal acceleration Gy is zero, the acceleration angle θxy is calculated as follows: when Gx>0, θxy=90°, and when Gx<0, θxy=−90°.

That is, when the lateral acceleration Gx is positive, and the longitudinal acceleration Gy is zero, the acceleration angle θxy is calculated as 90°, and when the lateral acceleration Gx is negative, and the longitudinal acceleration Gy is zero, the acceleration angle θxy is calculated as −90°.

An acceleration threshold GxyTH is set with respect to the acceleration angle θxy. As shown in FIG. 2, the acceleration threshold GxyTH changes in a curve with the acceleration angle θxy which changes in a range from 0° to 90°. That is, the acceleration threshold GxyTH changes with the acceleration angle θxy. The acceleration threshold GxyTH shown in FIG. 2 is used when both the lateral acceleration Gx and the longitudinal acceleration Gy have positive values so that the vehicle acceleration Gxy can exist in the first quadrant of FIG. 1. Since the number of combinations of positive and negative of the lateral acceleration Gx and the longitudinal acceleration Gy is four in total, the vehicle acceleration Gxy exists in any one of the first, second, third, and fourth quadrants of FIG. 1.

Assuming that the load sensor 3 is installed on only one side in the lateral direction of the vehicle, the load detected by the load sensor 3 varies largely due to concentration of the load on the one side. Therefore, an error in the class determination can be effectively reduced by using the lateral acceleration Gx detected by the lateral acceleration sensor 6.

In contrast, assuming that the load sensor 3 is installed on only one side in the longitudinal direction of the vehicle, the load detected by the load sensor 3 varies largely due to concentration of the load on the one side. Therefore, an error in the class determination can be effectively reduced by using the longitudinal acceleration Gy detected by the longitudinal acceleration sensor 5.

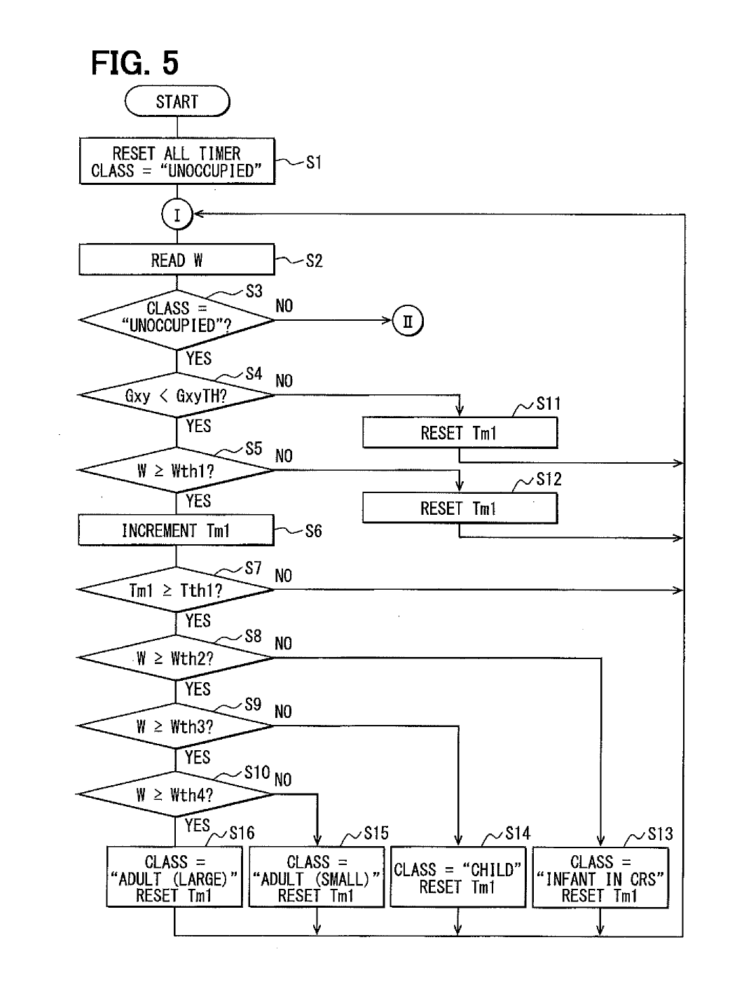

Next, a class determination process performed by the occupant classification unit 4 is described below with reference to FIGS. 5-10.

Firstly, at S1, timers Tm1, Tm2, Tm3, Tm4, Tm5, Tm6, Tm7, and Tm8 are reset to initial values (e.g., zero), and the class of the load W is reset to “unoccupied”. Then, at S2, the load W is calculated by reading and converting the load signal. Then, at S3, it is determined whether the class remains set to “unoccupied”. If the class remains set to “unoccupied” corresponding to YES at S3, it is determined at S4 whether the vehicle acceleration Gxy is less than the acceleration threshold GxyTH. Then, if the vehicle acceleration Gxy is not less than the acceleration threshold GxyTH corresponding to NO at S4, the timer Tm1 is reset at S11, and the class determination process returns to S2. In contrast, if the vehicle acceleration Gxy is less than the acceleration threshold GxyTH corresponding to YES at S4, it is determined at S5 whether the load W is not less than the first load threshold Wth1. If the load W is not less than the first load threshold Wth1 corresponding to YES at S5, the timer Tm1 is incremented at S6, and then it is determined at S7 whether the timer Tm1 reaches a first time threshold Tth1. In contrast, if the load W is less than the first load threshold Wth1 corresponding to NO at S5, the timer Tm1 is reset at S12, and the class determination process returns to S2.

If the timer Tm1 reaches the first time threshold Tth1 corresponding to YES at S7, it is determined at S8 whether the load W is not less than the second load threshold Wth2. in contrast, if the timer Tm1 does not reach the first time threshold Tth1 corresponding to NO at S7, the class determination process returns to S2.

If the load W is not less than the second load threshold Wth2 corresponding to YES at S8, it is determined at S9 whether the load W is not less than the third load threshold Wth3. In contrast, if the load W is less than the second load threshold Wth2 corresponding to NO at S8, the class is determined as “infant in CRS” at S13, and also the timer tm1 is reset at S13.

If the load W is not less than the third load threshold Wth3 corresponding to YES at S9, it is determined at S10 whether the load W is not less than the fourth load threshold Wth4. In contrast, if the load W is less than the third load threshold Wth3 corresponding to NO at S9, the class is determined as “child” at S14, and also the timer tm1 is reset at S14.

If the load W is less than the fourth load threshold Wth4 corresponding to NO at S10, the class is determined as “adult (small)” at S15, and also the timer tm1 is reset at S15. In contrast, if the load W is not less than the fourth load threshold Wth4 corresponding to YES at S10, the class is determined as “adult (large)” at S16, and also the timer Tm1 is reset at S16.

In this way, when the occupant sits on the sitting portion 2 of the seat 1, an initial classification is performed so that the load W can be compared with the load thresholds Wth1 Wth2, Wth3, and Wth4 and classified based on the comparison result into one of the classes: “infant in CRS”, “child”, “adult (large)”, and “adult (small)”.

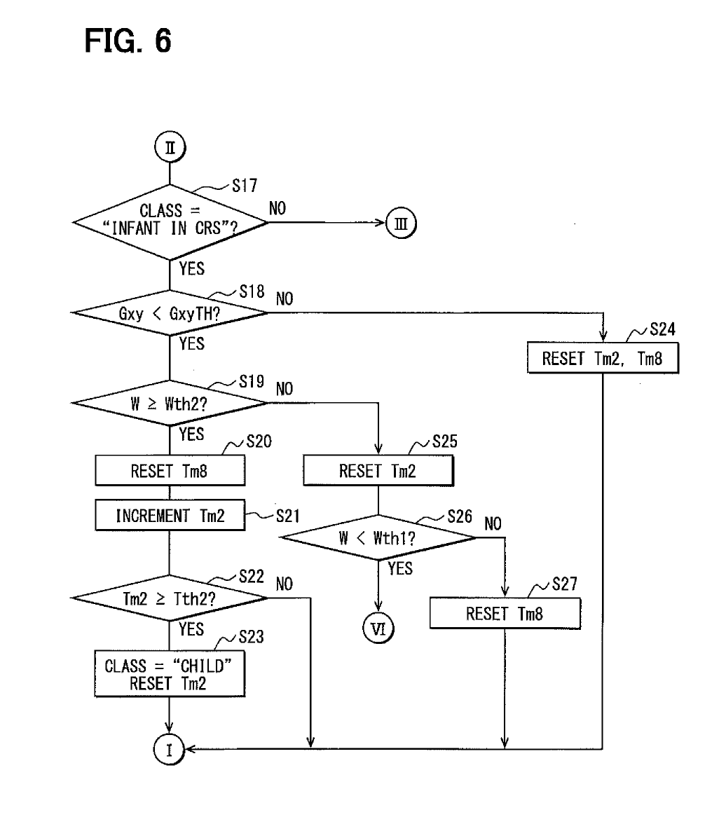

If the class is not “unoccupied” corresponding to NO at S3, i.e., if the class is any one of “infant in CRS”, “child”, “adult (large)”, and “adult (small)” corresponding to NO at S3, the class determination process proceeds to S17 shown in FIG. 6. At S17, it is determined whether the class is “infant in CRS”. If the class is “infant in CRS” corresponding to YES at S17, it is determined at S18 whether the vehicle acceleration Gxy is less than the acceleration threshold GxyTH. Then, if the vehicle acceleration Gxy is not less than the acceleration threshold GxyTH corresponding to NO at S18, the timers Tm2 and Tm4 are reset at S24, and the class determination process returns to S2. In contrast, if the vehicle acceleration Gxy is less than the acceleration threshold GxyTH corresponding to YES at S18, it is determined at S19 whether the load W is not less than the second load threshold Wth2. lithe load W is not less than the second load threshold Wth2 corresponding to YES at S19, the timer Tm8 is reset at S20, and the timer Tm2 is incremented at S21. Then, it is determined at S22 whether the timer Tm2 reaches a second time threshold Tth2. If the timer Tm2 reaches the second time threshold Tth2 corresponding to YES at S22, the class is determined as “child” at S23, the timer Tm2 is reset at S23, and then the class determination process returns to S2. In contrast, if the timer Tm2 does not reach the second time threshold Tth2 corresponding to NO at S22, the class determination process returns to S2 by skipping S23.

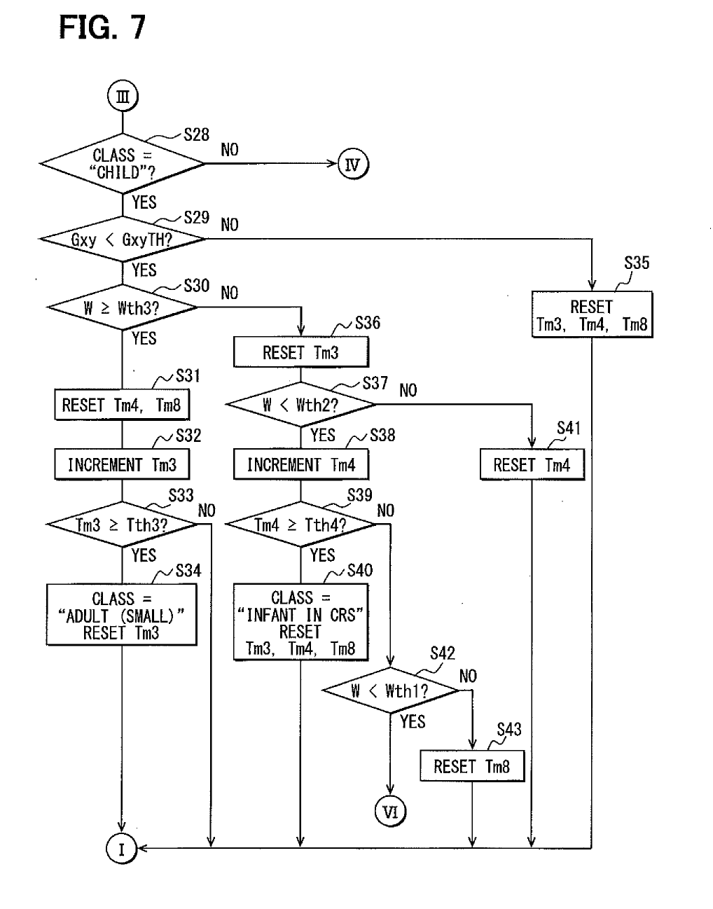

If the load W is less than the second load threshold Wth2 corresponding to NO at S19, the timer Tm2 is reset at S25, and it is determined at S26 whether the load W is less than the first load threshold Wth1. If the load W is less than the first load threshold Wth1 corresponding to YES at S26, the class determination process proceeds to S28 shown in FIG. 7. In contrast, if the load W is not less than the first load threshold Wth1 corresponding to NO at S26, the timer Tm8 is reset at S27, and the class determination process returns to S2 shown in FIG. 5.

If the class is not “infant in CRS” corresponding to NO at S17, i.e., if the class is any one of “child”, “adult (large)”, and “adult (small)” corresponding to NO at S17, the class determination process proceeds to S28 shown in FIG. 7. At S28, it is determined whether the class is “child”. If the class is “child” corresponding to YES at S28, it is determined at S29 whether the vehicle acceleration Gxy is less than the acceleration threshold GxyTH. Then, if the vehicle acceleration Gxy is not less than the acceleration threshold GxyTH corresponding to NO at S29, the timers Tm3, Tm4, and Tm8 are reset at S35, and the class determination process returns to S2. In contrast, if the vehicle acceleration Gxy is less than the acceleration threshold GxyTH corresponding to YES at S29, it is determined at S30 whether the load W is not less than the third load threshold Wth3. If the load W is not less than the third load threshold Wth3 corresponding to YES at S30, the timers Tm4 and Tm8 are reset at S31, and the timer Tm3 is incremented at S32. Then, it is determined at S33 whether the timer Tm3 reaches a third time threshold Tth3. If the timer Tm3 reaches the third time threshold Tth3 corresponding to YES at S33, the class is determined as “adult (small)” at S34, the timer Tm3 is reset at S34, and than the class determination process returns to S2. In contrast, if the timer Tm3 does not reach the third time threshold Tth3 corresponding to NO at S33, the class determination process returns to S2 by skipping S34.

If the load W is less than the third load threshold Wth3 corresponding to NO at S30, the timer Tm3 is reset at S36, and it is determined at S37 whether the load W is less than the second load threshold Wth2. If the load W is less than the second load threshold Wth2 corresponding to YES at S37, the timer Tm4 is incremented at S38, and it is determined at S39 whether the timer Tm4 reaches a fourth time threshold Tth4. If the timer Tm4 reaches the fourth time threshold Tth4 corresponding to YES at S39, the class is determined as “infant in CRS” at S40, the timers Tm3, Tm4, and Tm8 are reset at S40, and then the class determination process returns to S2.

If the load W is not less than the second load threshold Wth2 corresponding to NO at S37, the timer Tm4 is reset at S41, and then the class determination process returns to S2. If the timer Tm4 does not reach the fourth time threshold Tth4 corresponding to NO at S39, it is determined at S42 whether the load W is less than the first load threshold Wth1. If the load W is less than the first load threshold Wth1 corresponding to YES at S42, the class determination process proceeds to S69 shown in FIG. 10. In contrast, if the load W is not less than the first load threshold Wth1 corresponding to NO at S42, the timer Tm8 is reset at S43, and then the class determination process returns to S2.

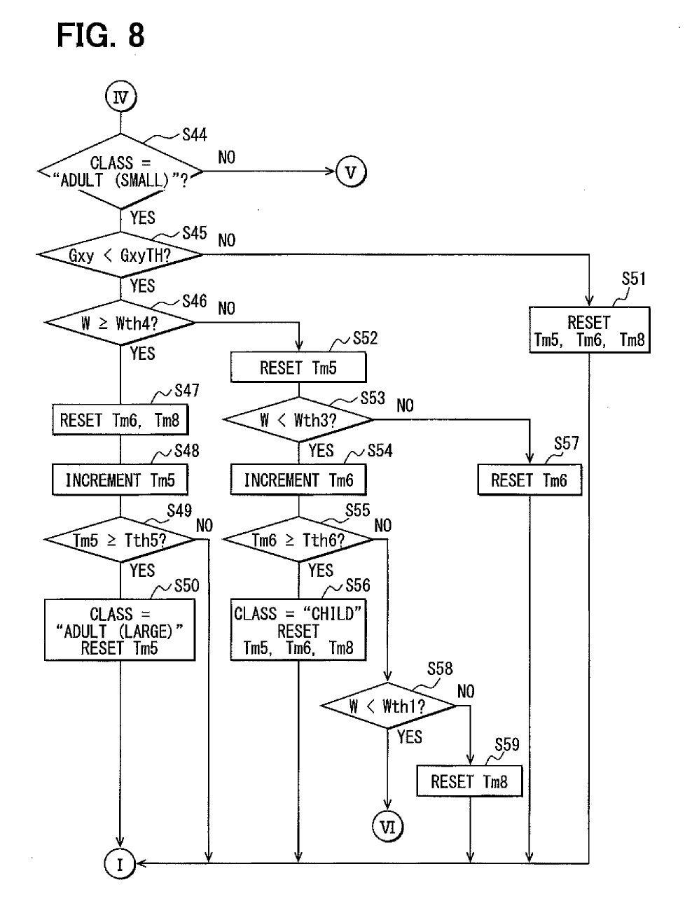

If the class is not “child” corresponding to NO at S28, i.e., if the class is “adult (large)” or “adult (small)” corresponding to NO at S28, the class determination process proceeds to S44 shown in FIG. 8. At S44, it is determined whether the class is “adult (small)”. If the class is “adult (small)” corresponding to YES at S44, it is determined at S45 whether the vehicle acceleration Gxy is less than the acceleration threshold GxyTH. Then, if the vehicle acceleration Gxy is not less than the acceleration threshold GxyTH corresponding to NO at S45, the timers Tm5, Tm6, and Tm8 are reset at S51, and the class determination process returns to S2. In contrast, if the vehicle acceleration Gxy is less than the acceleration threshold GxyTH corresponding to YES at S45, it is determined at S46 whether the load W is not less than the fourth load threshold Wth4. If the load W is not less than the fourth load threshold Wth4 corresponding to YES at S46, the timers Tm6 and Tm8 are reset at S47, and the timer Tm5 is incremented at S48. Then, it is determined at S49 whether the timer Tm5 reaches a fifth time threshold Tth5. If the timer Tm5 reaches the fifth time threshold Tth5 corresponding to YES at S49, the class is determined as “adult (large)” at S50, the timer Tm5 is reset at S34, and then the class determination process returns to S2. In contrast, if the timer Tm5 does not reach the fifth time threshold Tth5 corresponding to NO at S49, the class determination process returns to S2 by skipping S50.

If the load W is less than the fourth load threshold Wth4 corresponding to NO at S46, the timer Tm5 is reset at S52, and it is determined at S53 whether the load W is less than the third load threshold Wth3. If the load W is less than the third load threshold Wth3 corresponding to YES at S53, the timer Tm6 is incremented at S54, and it is determined at S55 whether the timer Tm6 reaches a sixth time threshold Tth6. If the timer Tm6 reaches the sixth time threshold Tth6 corresponding to YES at S55, the class is determined as “child” at S56, the timers Tm5, Tm6, and Tm8 are reset at S56, and then the class determination process returns to S2. If the load W is not less than the third load threshold Wth3 corresponding to NO at S57, the timer Tm6 is reset at S57, and then the class determination process returns to S2. If the timer Tm6 does not reach the sixth time threshold Tth6 corresponding to NO at S55, it is determined at S58 whether the load W is less than the first load threshold Wth1. If the load W is less than the first load threshold Wth1 corresponding to YES at S58, the class determination process proceeds to S69 shown in FIG. 10. In contrast, if the load W is not less than the first load threshold Wth1 corresponding to NO at S58, the timer Tm8 is reset at S59, and then the class determination process returns to S2.

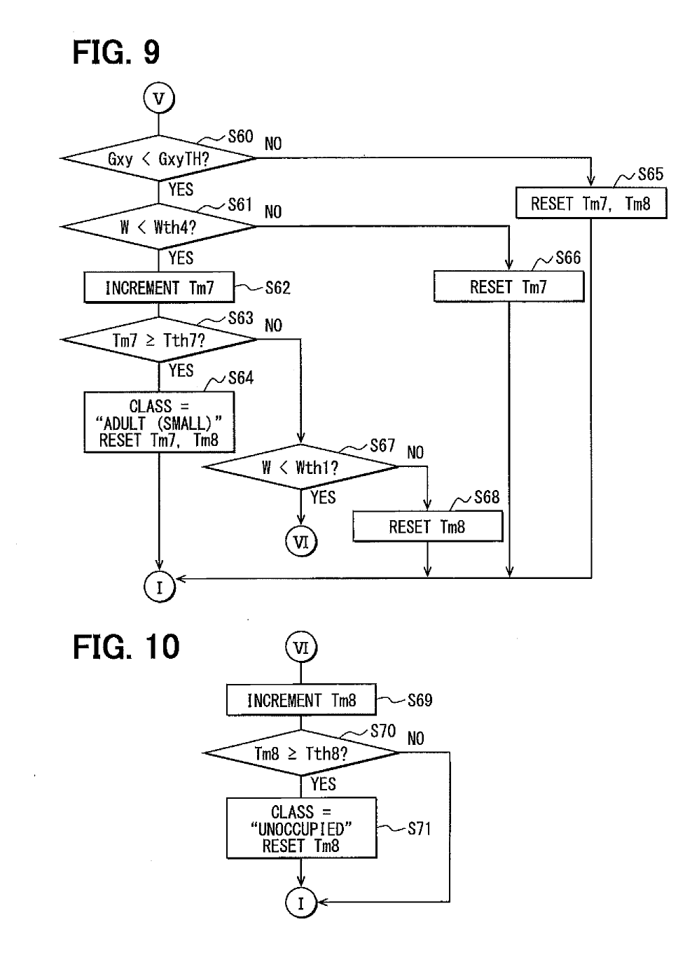

If the class is not “adult (small)” corresponding to NO at S44, i.e., if the class is “adult (large)” corresponding to NO at S44, the class determination process proceeds to S60 shown in FIG. 9. At S60, it is determined whether the vehicle acceleration Gxy is less than the acceleration threshold GxyTH. Then, if the vehicle acceleration Gxy is not less than the acceleration threshold GxyTH corresponding to NO at S60, the timers Tm7 and Tm8 are reset at S65, and the class determination process returns to S2. In contrast, if the vehicle acceleration Gxy is less than the acceleration threshold GxyTH corresponding to YES at S60, it is determined at S61 whether the load W is less than the fourth load threshold Wth4. If the load W is less than the fourth load threshold Wth4 corresponding to YES at S61, the timer Tm7 is incremented at S62, and it is determined at S63 whether the timer Tm7 reaches a seventh time threshold Tth7. If the timer Tm7 reaches the seventh time threshold Tth7 corresponding to YES at S63, the class is determined as “adult (small)” at S64, the timers Tm7 and Tm8 are reset at S64, and then the class determination process returns to S2. If the load W is not less than the fourth load threshold Wth4 corresponding to NO at S61, the timer Tm7 is reset at S66, and then the class determination process returns to S2. If the timer Tm7 does not reach the seventh time threshold Tth7 corresponding to NO at S63, it is determined at S67 whether the load W is less than the first load threshold Wth1. If the load W is less than the first load threshold Wth1 corresponding to YES at S67, the class determination process proceeds to S69 shown in FIG. 10. In contrast, if the load W is not less than the first load threshold Wth1 corresponding to NO at S67, the timer Tm8 is reset at S68, and then the class determination process returns to S2.

At S69, shown in FIG. 11, to which the class determination process proceeds when an affirmative determination is made at S26 in FIG. 6, at S42 in FIG. 7, at S58 in FIG. 8, or at S67 in FIG. 9, the timer Tm8 is incremented. Then, at S70, it is determined whether the timer Tm8 reaches an eighth time threshold Tth8. If the timer Tm8 reaches the eighth time threshold Tth8 corresponding to YES at S70, the class is determined as “unoccupied” at S71, the timer Tm8 is reset at S71, and then the class determination process returns to S2. In contrast, if the timer Tm8 does not reach the eighth time threshold Tth8 corresponding to NO at S70, the class determination process returns to S2 by skipping S71.

The first time threshold Tth1 is a threshold for the timer Tm1 used to initially classify the load W, which remains classified as “unoccupied”, to any one of “infant in CRS”, “child”, “adult (small)”, and “adult (large)”. Since it is necessary to classify the load W immediately when the occupant gets in the vehicle, the first time threshold Tth1 is set to a relatively small value. For example, the first time threshold Tth1 can be 3 seconds.

The second time threshold Tth2 is a threshold for the timer Tm2 used to cause the class of the load W to transition from “infant in CRS” to “child”. To ensure reliability and stability of the class transition, the second time threshold Tth2 is set larger than the first time threshold Tth1. For example, the second time threshold Tth2 can be from 20 seconds to 30 seconds.

The third time threshold Tth3 is a threshold for the timer Tm3 used to cause the class to transition from “child” to “adult (small)”. To ensure reliability and stability of the class transition, the third time threshold Tth3 is set larger than the first time threshold Tth1. For example, the third time threshold Tth3 can be from 20 seconds to 30 seconds.

The fourth time threshold Tth4 is a threshold for the timer Tm4 used to cause the class to transition from “child” to “infant in CRS”. To ensure reliability and stability of the class transition, the fourth time threshold Tth4 is set larger than the first time threshold Tth1. For example, the fourth time threshold Tth4 can be from 20 seconds to 30 seconds.

The fifth time threshold Tth5 is a threshold for the timer Tm5 used to cause the class to transition from “adult (small)” to “adult (large)”. To ensure reliability and stability of the class transition, the fifth time threshold Tth5 is set larger than the first time threshold Tth1. For example, the fifth time threshold Tth5 can be from 20 seconds to 30 seconds.

The sixth time threshold Tth6 is a threshold for the timer Tm6 used to cause the class to transition from “adult (small)” to “child”. To ensure reliability and stability of the class transition, the sixth time threshold Tth6 is set larger than the first time threshold Tth1. For example, the sixth time threshold Tth6 can be from 20 seconds to 30 seconds.

The seventh time threshold Tth7 is a threshold for the timer Tm7 used to cause the class to transition from “adult (large)” to “adult (small)”. To ensure reliability and stability of the class transition, the seventh time threshold Tth7 is set larger than the first time threshold Tth1. For example, the seventh time threshold Tth7 can be from 20 seconds to 30 seconds.

The eighth time threshold Tth8 is a threshold for the timer Tm8 used to classify the load W, which remains classified as any one of “infant in CRS”, “child”, “adult (small)”, and “adult (large)”, into “unoccupied”. Since it is necessary to classify the load W into “unoccupied” in a short time when the occupant gets out of the vehicle and then another occupant gets in the vehicle, the eighth time threshold Tth8 is set to a relatively small value like the first time threshold value Tth1. For example, the eighth time threshold Tth8 can be 2 seconds.

As described above, it is determined whether the vehicle acceleration Gxy is less than the acceleration threshold GxyTH at S4, S18, S29, S45, and S60. If the vehicle acceleration Gxy is not less than the acceleration threshold GxyTH, the corresponding timer is reset so that the corresponding class determination can be stopped.

At this time, the occupant classification unit 4 retains the load W in the last class as determined at step before S4, S18, S29, S45, and S60.

As described above, according to the embodiment, when the vehicle acceleration Gxy, which is the square root of the sum of the square of the detection value Gx of the lateral acceleration sensor 6 and the square of the detection value Gy of the longitudinal acceleration sensor 5, is not less than the predetermined acceleration threshold GxyTH, the occupant classification unit 4 stops the class determination to prevent the class transition. In such an approach, even when the weight of the occupant is concentrated on the load sensor 3 due to acceleration while the vehicle is running, an error in the class determination can be prevented from occurring. Therefore, the airbag 7 is accurately controlled according to the size of the occupant.

Further, when the occupant classification unit 4 stops the class determination, the occupant classification unit 4 retains the load W in the last class. In such an approach, even when the weight of the occupant is concentrated on the load sensor 3 due to acceleration while the vehicle is running, an error in the class determination can be prevented from occurring. Therefore, the airbag 7 is accurately controlled according to the size of the occupant.

Further, according to the embodiment, the acceleration threshold GxyTH changes with the acceleration angle θxy. In such an approach, the occupant classification unit 4 can determine whether to stop the class determination based on the acceleration threshold GxyTH which is optimized according to a direction of the vehicle acceleration Gxy. Thus, the occupant classification unit 4 can determine whether to stop the class determination according to a change in posture of the occupant.

Assuming that the number of the load sensor 3 is one, the detection load varies largely and frequently, and therefore an error in the class determination is likely to occur. According to the embodiment, since the longitudinal acceleration sensor 5 and the lateral acceleration sensor 6 are included to detect accelerations in two directions, the acceleration threshold

GxyTH can be set according to acceleration in any direction. Thus, even when the weight of the occupant is concentrated on the load sensor 3 due to acceleration while the vehicle is running, an error in the class determination can be prevented from occurring. Therefore, the airbag 7 is accurately controlled according to the size of the occupant.

The longitudinal acceleration sensor 5 and the lateral acceleration sensor 6 can be combined with the occupant classification unit 4 into a single unit. In this case, if the vehicle is equipped with the vehicle behavior stabilization system, the single unit can share acceleration information with the vehicle behavior stabilization system to synchronize the acceleration detection with the load detection. In such an approach, the occupant classification can be accurately achieved at low cost.

The longitudinal acceleration sensor 5 and the lateral acceleration sensor 6 can be combined with the airbag driver 8 into a single unit. In this case, if the vehicle is equipped with the vehicle behavior stabilization system, the single unit can share acceleration information with the vehicle behavior stabilization system to synchronize the acceleration detection with the load detection. In such an approach, the occupant classification can be accurately achieved at low cost.

(Modification)

While the present disclosure has been described with reference to the embodiment, it is to be understood that the disclosure is not limited to the embodiment. The present disclosure is intended to cover various modifications and equivalent arrangements within the spirit and scope of the present disclosure.

For example, in the embodiment, the class determination process causes the class of the load W to transition from a present class to an adjacent class that is immediately adjacent to the present class (i) when the load W not less than a first threshold load, which is defined between the present class and the adjacent class that is larger than the present class, remains detected for a first threshold time, or (ii) when the load W not greater than a second threshold load, which is defined between the present class and the adjacent class that is smaller than the present class, remains detected for a second threshold time. However, the class determination process is not limited to that described in the embodiment.

What is claimed is:

1. An occupant classification apparatus comprising:
a load sensor configured to detect a load of an occupant on a seat of a vehicle;
a longitudinal acceleration sensor configured to detect a longitudinal acceleration in a longitudinal direction of the vehicle;
a lateral acceleration sensor configured to detect a lateral acceleration in a lateral direction of the vehicle; and
a determinator configured to perform a class determination process to determine presence or absence of the occupant and a size of the occupant, the class determination process classifying the load into one of a plurality of classes based on a plurality of predetermined load thresholds, wherein
the determinator stops the class determination process when a vehicle acceleration is not less than a predetermined acceleration threshold, and
the vehicle acceleration is the square root of the sum of the square of the longitudinal acceleration and the square of the lateral acceleration.

2. The occupant classification apparatus according to claim 1, wherein
when the determinator stops the class determination process, the determinator retains the load in the last class before stopping the class determination process.

3. The occupant classification apparatus according to claim 1, wherein
the acceleration threshold changes with an acceleration angle which is defined by the longitudinal acceleration and the lateral acceleration.

4. The occupant classification apparatus according to claim 1, wherein
the number of load sensors is one.

5. The occupant classification apparatus according to claim 1, wherein
the longitudinal acceleration sensor and the lateral acceleration sensor are incorporated in the determinator.

6. The occupant classification apparatus according to claim 1, wherein
the longitudinal acceleration sensor and the lateral acceleration sensor are incorporated in an airbag driver for driving an airbag.
